(19) United States
(12) Patent Application Publication
(10) Pub. No.: US 2026/0205687 A1
(43) Pub. Date: Jul. 16, 2026

(54) Electronic Device and Operating Method thereof

(71) Applicant: COMPAL ELECTRONICS, INC., Taipei City (TW)

(72) Inventors: Han-Ming Wu, Taipei City (TW); Wen-Hsien Chin, Taipei City (TW); Yi-Ching Hsieh, Taipei City (TW); Yu-Ling Lee, Taipei City (TW)

(73) Assignee: COMPAL ELECTRONICS, INC., Taipei City (TW)

(21) Appl. No.: 19/321,306

(22) Filed: Sep. 8, 2025

Related U.S. Application Data
(60) Provisional application No. 63/692,173, filed on Sep. 8, 2024.
(60) Provisional application No. 63/728,133, filed on Dec. 4, 2024.

(51) Int. Cl. H04N 23/667; G06F 1/16; G06F 3/04817; G06F 21/84; H04N 23/51

(52) U.S. Cl. CPC H04N 23/667; G06F 1/1686; G06F 21/84; H04N 23/51; G06F 3/04817

(57) ABSTRACT

An electronic device includes a display body, a hinge structure, and a computing body. The display body includes a display module. The computing body includes a processing unit, a camera window, and a switchable camera module, and has opposite first and second ends. The switchable camera module and the camera window are arranged adjacent to the second end. The switchable camera module includes a carrier element, at least one camera unit, a blocking member, and a switching mechanism. The switching mechanism is connected to carrier element for driving carrier element to switch, such that only one of at least one camera unit and blocking member is exposed at the camera window. When at least one camera unit is exposed at camera window, processing unit controls display module to display camera mode screen. When blocking member is exposed at camera window, processing unit controls display module to display privacy mode screen.

### CROSS-REFERENCE TO RELATED APPLICATION

This application claims the priority benefit of U.S. Provisional Patent Application No. 63/728,133, filed on Dec. 4, 2024, and U.S. Provisional Patent Application No. 63/692,173, filed on Sep. 8, 2024. The entirety of each of the above-mentioned patent applications is hereby incorporated by reference herein and made a part of this specification.

### BACKGROUND

### Technical Field

The present invention relates to an electronic device and an operating method thereof, and particularly relates to an electronic device having a switchable camera module and an operating method thereof.

### Related Art

Laptop computers serve as important tools for modern people in daily life and work. To enhance the operating experience, laptop computers with switching mode functions integrated into the operating end or display end have been proposed to provide users with different interactive experiences. Traditional laptop computers usually add camera lenses through external modules for convenient use or detachable storage. However, such designs require relatively additional labor and costs, and also have compatibility issues with the system in terms of configuration. In addition, switching modules built into laptop computers may provide consumers with additional interactive experiences.

### SUMMARY

The present invention provides an electronic device and an operating method thereof, which may switch to different camera modes by simple operation and automatically execute corresponding program software or provide privacy protection.

The present invention provides an electronic device, including a display body, a hinge structure, and a computing body. The display body includes a display module. The hinge structure is pivotally connected to the display body. The computing body is pivotally connected to the display body. The computing body includes a processing unit, a camera window, and a switchable camera module, and has opposite first and second ends. The first end is pivotally connected to the hinge structure. The camera window is configured on an operation surface of the computing body. The switchable camera module and the camera window are arranged adjacent to the second end. The switchable camera module includes a carrier element, at least one camera unit, a blocking member, and a switching mechanism. The at least one camera unit is configured on the carrier element. The blocking member is configured on the carrier element. The switching mechanism is connected to the carrier element for driving the carrier element to switch, such that only one of the at least one camera unit and the blocking member is exposed at the camera window. When the at least one camera unit is exposed at the camera window, the processing unit controls the display module to display a camera mode screen. When the blocking member is exposed at the camera window, the processing unit controls the display module to display a privacy mode screen.

In an embodiment of the present invention, the computing body further includes a keyboard module and a touchpad exposed on the operation surface, the keyboard module is configured adjacent to the first end, the touchpad is configured adjacent to the second end, and the switchable camera module and the camera window are located on the same side of the touchpad.

In an embodiment of the present invention, there are have two side edges opposite to each other between the first end and the second end, and the switchable camera module and the camera window are located adjacent to one of the two side edges.

In an embodiment of the present invention, one of the two side edges adjacent to the switchable camera module and the camera window has an opening, and the switching mechanism is partially exposed at the opening.

In an embodiment of the present invention, the carrier element is a rotating disk, the switching mechanism is a driving gear and meshes with the carrier element, and the switching mechanism partially exposed at the opening is configured to allow the user to toggle within the opening to drive the carrier element to rotate.

In an embodiment of the present invention, the carrier element and the switching mechanism are an integrally formed sliding component, and the switching mechanism has a toggle lever, exposed to a portion of the opening, and is configured to allow the user to slide within the opening along an extending direction of the corresponding two side edges to drive the carrier element.

In an embodiment of the present invention, the at least one camera unit includes a first camera unit and a second camera unit, and the optical zoom magnification of the first camera unit is different from the optical zoom magnification of the second camera unit.

In an embodiment of the present invention, when the first camera unit or the second camera unit is exposed at the camera window, the processing unit controls the display module to display a camera mode confirmation screen.

In an embodiment of the present invention, when the display module displays the camera mode confirmation screen, the processing unit controls the display module to display a first camera mode screen or a second camera mode screen according to the confirmation information.

In an embodiment of the present invention, the electronic device further includes an angle sensor configured to sense a rotation angle of the hinge structure to obtain angle information, and the processing unit switches the electronic device to a laptop mode or a tablet mode according to the angle information.

In an embodiment of the present invention, when the electronic device is in the tablet mode, the camera window faces away from the display surface of the display body.

In an embodiment of the present invention, the electronic device further includes a motion sensor configured to sense the directionality of the display module and the switchable camera module to provide direction information, and when the electronic device is in the tablet mode, the processing unit adjusts the screen orientation of the display module according to the direction information.

In an embodiment of the present invention, the display screen of the display module includes a camera function icon, and when the electronic device is in the tablet mode, the processing unit adjusts the position displayed of the camera function icon on the display screen according to positions of the switchable camera module and the camera window, so that the position of the camera function icon corresponds adjacent to the switchable camera module and the camera window.

In an embodiment of the present invention, the switchable camera module further includes a light-emitting unit electrically connected to the processing unit, and when the electronic device is in the tablet mode, and at least one camera unit is exposed at the camera window, the processing unit is used to activate the light-emitting unit to provide illumination light.

In an embodiment of the present invention, the display body further includes a touch module electrically connected to the processing unit, and the processing unit controls the display module to display multiple software touch icons and activate corresponding multiple software programs according to touch information of the display module.

In an embodiment of the present invention, the processing unit controls the display module to display multiple software touch icons and activate corresponding multiple software programs according to touch pressure information of the switching mechanism.

The present invention provides an operating method for an electronic device, and the electronic device includes a display body, a hinge structure, and a computing body. The display body includes a display module, the computing body includes a processing unit, a camera window, and a switchable camera module, and has opposite first and second ends. The hinge structure is pivotally connected between the first end and the display body. The camera window is configured on an operation surface of the computing body. The switchable camera module and the camera window are arranged adjacent to the second end, and the switchable camera module includes a carrier element, at least one camera unit, a blocking member, and a switching mechanism. The at least one camera unit is configured on the carrier element. The blocking member is configured on the carrier element. The switching mechanism is connected to the carrier element and configured to drive the carrier element. The operating method of the electronic device includes the following. The switching mechanism is operated to switch the at least one camera unit to be exposed at the camera window, and the display module is caused to correspondingly display at least one camera mode screen. Also, the switching mechanism is operated to switch the blocking member to be exposed at the camera window, and the display module is caused to correspondingly display a privacy mode screen.

In an embodiment of the present invention, the at least one camera unit includes a first camera unit and a second camera unit having different optical zoom magnifications. The operating method of the electronic device further includes the following. The display module is controlled to display a first camera mode screen or a second camera mode screen according to confirmation information.

In an embodiment of the present invention, the operating method further includes the following. An included angle between the display body and the computing body is sensed to provide angle information. Also, the electronic device is switched to a laptop mode or a tablet mode according to the angle information.

In an embodiment of the present invention, when the electronic device is in the tablet mode, the display screen of the display module further includes a camera function icon. The operating method of the electronic device further includes the following. The directionality of the display module and the switchable camera module is sensed to provide direction information. The screen orientation displayed of the display module is adjusted according to the direction information. Also, the position displayed of the camera function icon on the display screen is controlled, so that a position of the camera function icon corresponds adjacent to the switchable camera module and the camera window.

Based on the above, in the electronic device and the operating method thereof of the invention, the electronic device includes a display body, a hinge structure, and a computing body. The display body includes a display module, the computing body includes a processing unit, a camera window, and a switchable camera module, and has opposite first and second ends. The hinge structure is pivotally connected between the first end and the display body. The camera window is configured on an operation surface of the computing body. The switchable camera module and the camera window are configured adjacent to the second end, and the switchable camera module includes a carrier element, at least one camera unit, a blocking member, and a switching mechanism. The at least one camera unit is configured on the carrier element. The blocking member is configured on the carrier element. The switching mechanism is connected to the carrier element for driving the carrier element. When the switching mechanism is operated to switch the at least one camera unit to be exposed at the camera window, the processing unit controls the display module to correspondingly display at least one camera mode screen. In addition, when the switching mechanism is operated to switch the blocking member to be exposed at the camera window, the processing unit controls the display module to correspondingly display a privacy mode screen. In this way, different camera modes may be switched to by simple operation and corresponding program software may be automatically executed or privacy protection may be provided.

To make the foregoing features and advantages of the present invention more comprehensible, embodiments are specifically provided below and described in detail with the accompanying drawings as follows.

### BRIEF DESCRIPTION OF DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a perspective schematic diagram of an electronic device in an open state according to an embodiment of the present invention.

FIG. 2A and FIG. 2B are schematic diagrams of a switchable camera module of the electronic device in FIG. 1.

FIG. 3A and FIG. 3B are schematic diagrams of a switchable camera module according to another embodiment of the present invention.

FIG. 4A to FIG. 4C are schematic diagrams of the electronic device in FIG. 1 in different camera mode screens respectively.

FIG. 5 is a schematic diagram of a camera mode confirmation screen displayed when the electronic device in FIG. 1 switches camera mode screens.

FIG. 6 is a schematic diagram of placing a target object on the electronic device in FIG. 1.

FIG. 7 is a schematic diagram of a display screen of the electronic device in FIG. 6.

FIG. 8 is a perspective schematic diagram of the electronic device in FIG. 1 in a tablet state.

FIG. 9A and FIG. 9B are different partial enlarged schematic diagrams of the electronic device in FIG. 8 respectively.

FIG. 10A and FIG. 10B are schematic diagrams of camera mode screens of the electronic device in FIG. 8 respectively.

FIG. 11 is a schematic diagram showing the correspondence between the switchable camera module and camera mode screens of the electronic device in FIG. 1 under different operations.

FIG. 12A and FIG. 12B are schematic diagrams of camera mode screens of the electronic device in FIG. 8 in different directions respectively.

FIG. 13 is a step flow chart of an operating method of an electronic device according to an embodiment of the present invention.

### DESCRIPTION OF THE EMBODIMENTS

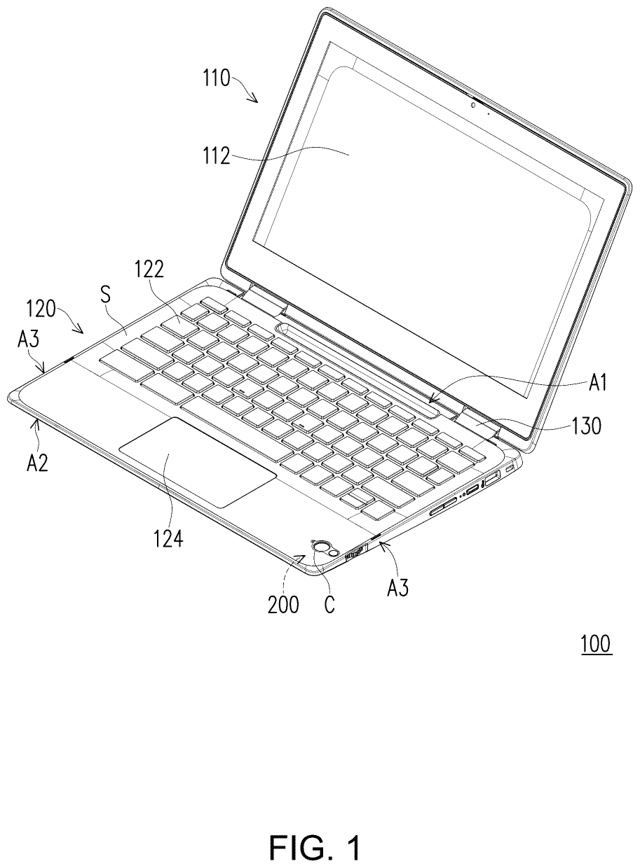

FIG. 1 is a perspective schematic diagram of an electronic device in an open state according to an embodiment of the present invention. Referring to FIG. 1, this embodiment provides an electronic device 100, including a display body 110, a computing body 120, and a hinge structure 130. The display body 110 is pivotally connected to the computing body 120 by the hinge structure 130, for rotating at the pivotal connection to open or close. The electronic device 100 is, for example, a laptop computer, and the display body 110 and the computing body 120 are, for example, a display end and an input interface end respectively. The display body 110 includes a display module 112 for providing images. The display module 112 is, for example, a light-emitting diode display panel (LED display), an organic light-emitting diode display panel (OLED display), or other types of display panels, and the present invention is not limited thereto.

The computing body 120 includes a processing unit (not shown), a camera window C, and a switchable camera module 200, and has a first end A1 and a second end A2 opposite to each other, in which the first end A1 is pivotally connected to the hinge structure 130. The computing body 120 has an operation surface S, and the camera window C is configured on the operation surface S of the computing body 120 for exposing part of the switchable camera module 200. The switchable camera module 200 and the camera window C are arranged adjacent to the second end A2 of the computing body 120. Specifically, the computing body 120 further includes a keyboard module 122 and a touchpad 124 exposed on the operation surface S. The keyboard module 122 is configured adjacent to the first end A1 of the computing body 120, the touchpad 124 is configured adjacent to the second end A2 of the computing body 120, and the switchable camera module 200 and the camera window C are located on the same side of the touchpad 124. More specifically, there are two side edges A3 opposite to each other between the first end A1 and the second end A2 of the computing body 120, and the switchable camera module 200 and the camera window C are located adjacent to one of the two side edges A3. For example, in this embodiment, the switchable camera module 200 may be selectively configured at one of two corners at the second end A2 of the computing body 120, such that the camera window C is relatively located at the two corners of the computing body 120.

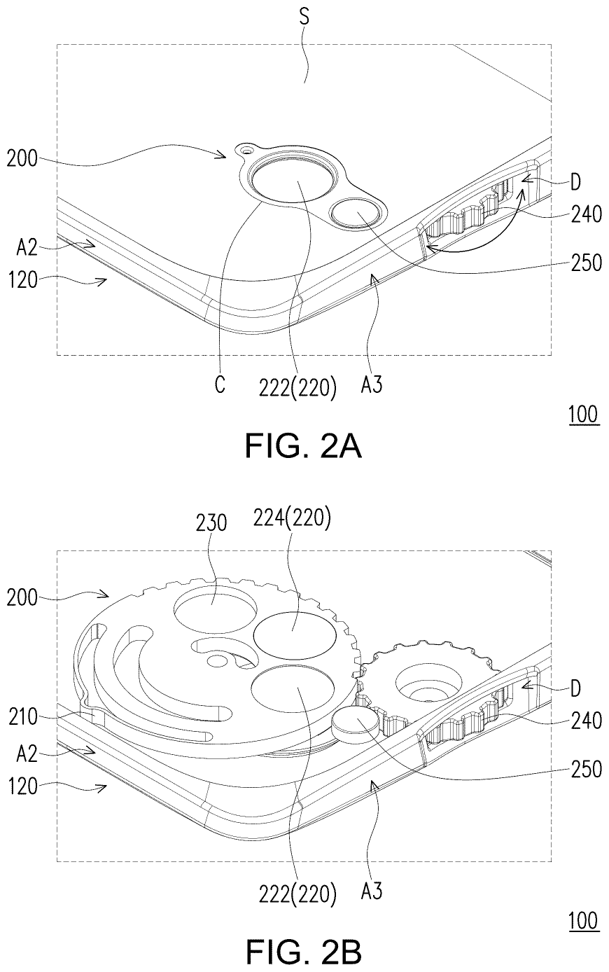

FIG. 2A and FIG. 2B are schematic diagrams of the switchable camera module of the electronic device in FIG. 1. For convenience of illustration, FIG. 2B hides the housing that displays the operation surface S of the computing body 120. Referring to FIG. 1 to FIG. 2B, the switchable camera module 200 includes a carrier element 210, at least one camera unit 220, a blocking member 230, and a switching mechanism 240. The carrier element 210 is used to carry the at least one camera unit 220 and the blocking member 230, and is connected to the switching mechanism 240. The at least one camera unit 220 is configured on the carrier element 210. In this embodiment, the at least one camera unit 220 includes a first camera unit 222 and a second camera unit 224, and the optical zoom magnification of the first camera unit 222 is different from the optical zoom magnification of the second camera unit 224. For example, the first camera unit 222 is, for example, a wide-angle lens, and the second camera unit 224 is, for example, an ultra-wide-angle lens, respectively used to perform general camera mode or macro camera mode, but the invention is not limited thereto.

The blocking member 230 is, for example, a light-blocking sheet, configured on the carrier element 210, and the material thereof may be selected to be the same as the material of the housing of the computing body 120. Specifically, the first camera unit 222, the second camera unit 224, and the blocking member 230 are respectively located at different positions on the carrier element 210, and are exposed at the camera window C by rotation or movement of the carrier element 210, the detailed implementation of which will be described in subsequent paragraphs.

The switching mechanism 240 is connected to the carrier element 210, and is used to drive the carrier element 210 to switch, such that only one of the at least one camera unit 220 and the blocking member 230 is exposed at the camera window C. In this embodiment, the carrier element 210 is, for example, a rotating disk, and the switching mechanism 240 is, for example, a driving gear, and meshes with the carrier element 210. In operation, one of the two side edges A3 adjacent to the switchable camera module 200 and the camera window C has an opening D, and the switching mechanism 240 of the switchable camera module 200 is partially exposed at the opening D. In other words, the switching mechanism 240 partially exposed at the opening D is used to allow the user to toggle the switching mechanism 240 at the position of the opening D to drive the carrier element 210 to rotate, as shown in FIG. 2A. Therefore, the user may switch one of the first camera unit 222, the second camera unit 224, and the blocking member 230 to be exposed at the camera window C by toggling the switching mechanism 240. In this embodiment, the switchable camera module 200 further includes a light-emitting unit 250, electrically connected to the processing unit, and used to be activated by the processing unit to provide illumination light.

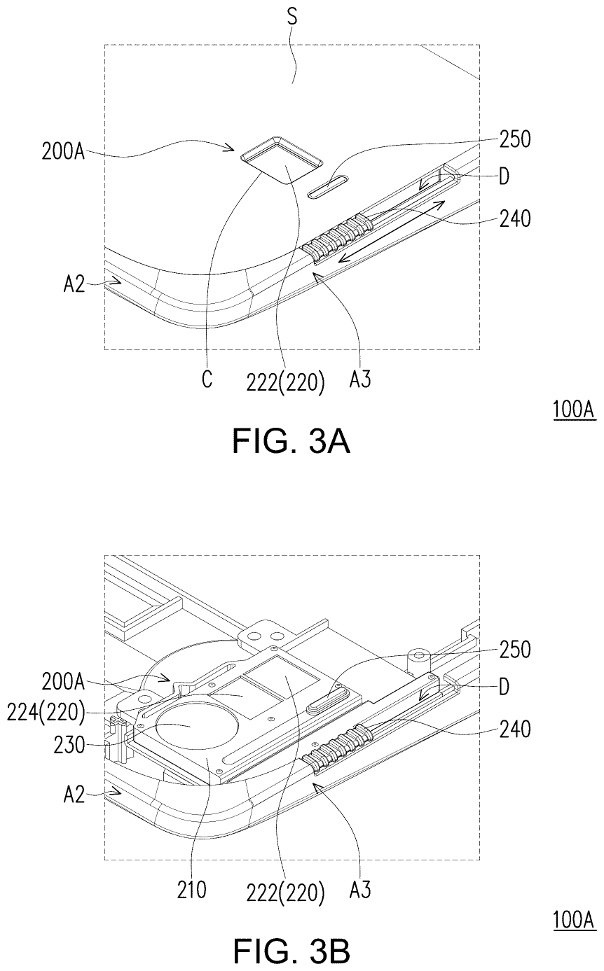

FIG. 3A and FIG. 3B are schematic diagrams of a switchable camera module according to another embodiment of the present invention. An electronic device 100A shown in this embodiment is similar to the electronic device 100 shown in FIG. 2A and FIG. 2B. The difference between the two is that, in this embodiment, the carrier element 210 and the switching mechanism 240 of the switchable camera module 200A are an integrally formed sliding component, in which the switching mechanism 240 has a toggle lever, exposed to a portion of the opening D, and is used to allow the user to slide at the position of the opening D along the extending direction of the corresponding two side edges A3 to drive the carrier element 210. Therefore, the user may switch one of the first camera unit 222, the second camera unit 224, and the blocking member 230 to be exposed at the camera window C by toggling the switching mechanism 240.

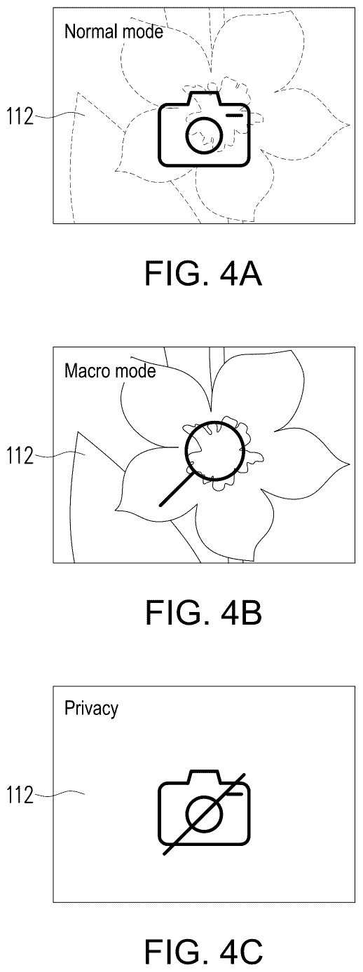

FIG. 4A to FIG. 4C are schematic diagrams of the electronic device in FIG. 1 in different camera mode screens respectively. Referring to FIG. 2A to FIG. 2B and FIG. 4A to FIG. 4C, the processing unit is electrically connected to the display module 112 and the switchable camera module 200, used to control the display screen of the display module 112 according to the switching state of the switchable camera module 200. When at least one camera unit 220 is exposed at the camera window C, the processing unit activates the function of the at least one camera unit 220 and controls the display module 112 to display the camera mode screen. For example, when the first camera unit 222 is exposed at the camera window C, the processing unit activates the function of the first camera unit 222 and controls the display module 112 to display a first camera mode screen, for example a general camera mode, as shown in FIG. 4A. When the second camera unit 224 is exposed at the camera window C, the processing unit activates the function of the second camera unit 224 and controls the display module 112 to display a second camera mode screen, for example a macro camera mode, as shown in FIG. 4B. When the blocking member 230 is exposed at the camera window C, the processing unit only controls the display module 112 to display the privacy mode screen, as shown in FIG. 4C. In this way, the operation may switch to different camera modes by simple operation and automatically execute corresponding program software or provide privacy protection. It is worth mentioning that, in this embodiment, when switching to the first camera mode screen, the second camera mode screen, or the privacy mode screen, a corresponding icon may be displayed for several seconds to prompt the user of the switched mode state. For example, when the switchable camera module 200 switches to the macro camera mode, an icon corresponding to the macro camera mode is displayed for several seconds and then disappear, so that school-age users may intuitively know the type of the current camera mode.

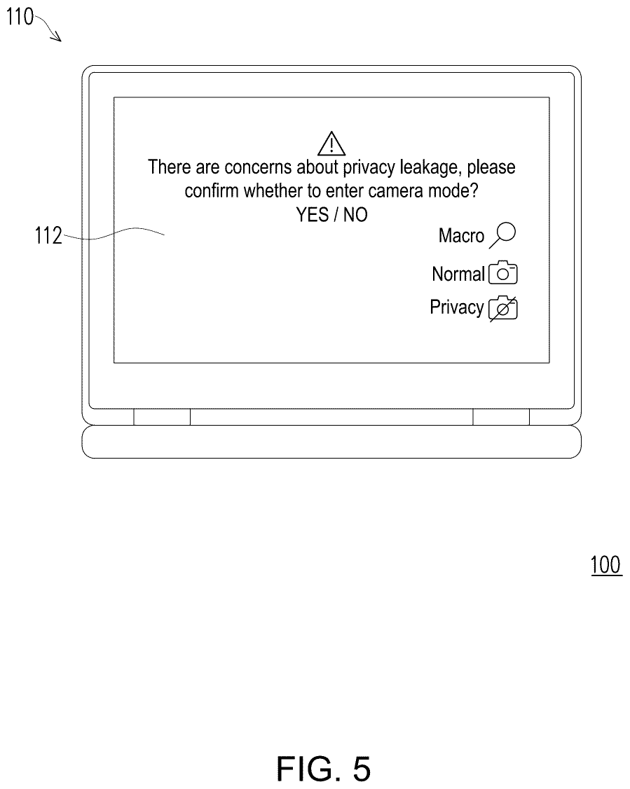

FIG. 5 is a schematic diagram of a camera mode confirmation screen displayed when the electronic device in FIG. 1 switches camera modes. Referring to FIG. 4A to FIG. 5, in this embodiment, when the first camera unit 222 or the second camera unit 224 is switched to be exposed at the camera window C, the processing unit controls the display module 112 to display the camera mode confirmation screen, as shown in FIG. 5, thereby prompting the user of the switching state to enhance the privacy effect. It is worth noting that when the blocking member 230 is exposed at the camera window C, the camera unit cannot function, and thus by design, the processing unit does not need to control the display module 112 to display the camera mode confirmation screen shown in FIG. 5. In addition, in this embodiment, when the display module 112 displays the camera mode confirmation screen, the processing unit may further control the display module 112 to display the first camera mode screen or the second camera mode screen according to the confirmation information. For example, after the display module 112 displays the camera mode confirmation screen, when the user selects confirmation, the processing unit controls the display module 112 to display the first camera mode screen or the second camera mode screen, as shown in FIG. 4A and FIG. 4B. If the user selects No in the camera mode confirmation screen, the processing unit controls the display module 112 to maintain displaying the original display screen, that is, the privacy mode screen, as shown in FIG. 4C. In this way, the privacy stability of using the electronic device 100 may be improved.

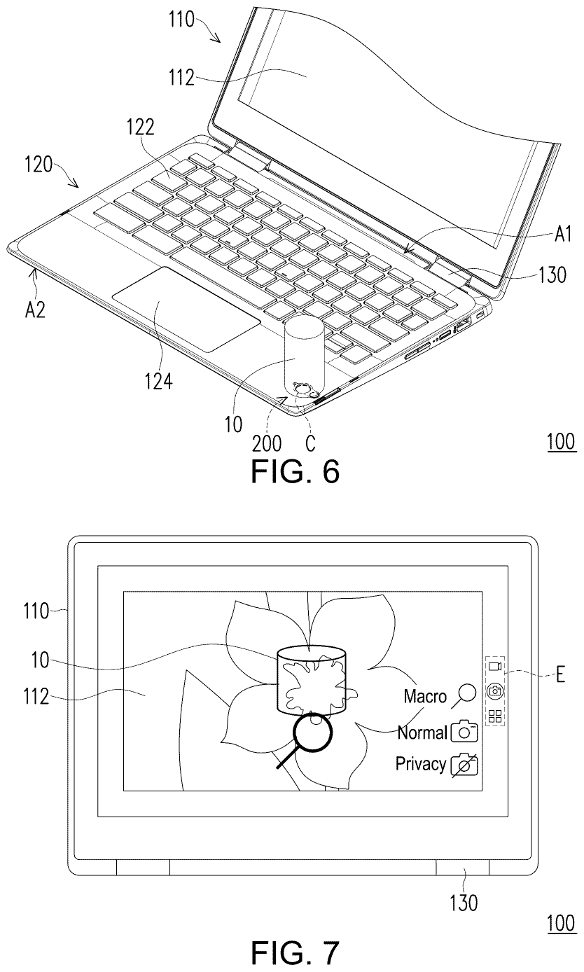

FIG. 6 is a schematic diagram of placing a target object on the electronic device in FIG. 1. FIG. 7 is a schematic diagram of the display screen of the electronic device in FIG. 6. In this embodiment, the user may selectively configure a target object 10 (for example, a petri dish) above the camera window C of the computing body 120. When the target object 10 is configured at the camera window C and the second camera unit 224 is switched to be exposed at the camera window C, the processing unit may control the display module 112 to further detect and switch to an observation mode, so as to control the display module 112 to display an icon of the observation mode, thereby prompting the user that in addition to being in the macro camera mode, the observation mode function is also available at this time, as shown in FIG. 7.

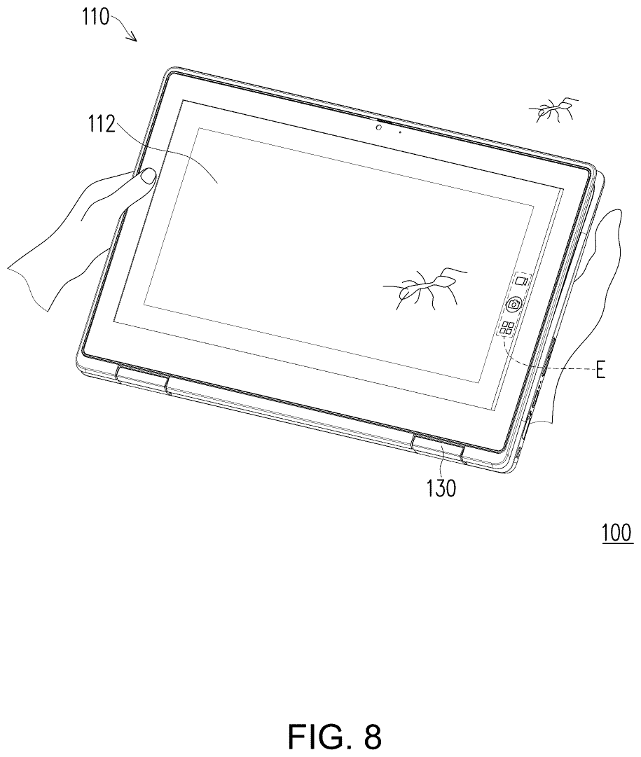

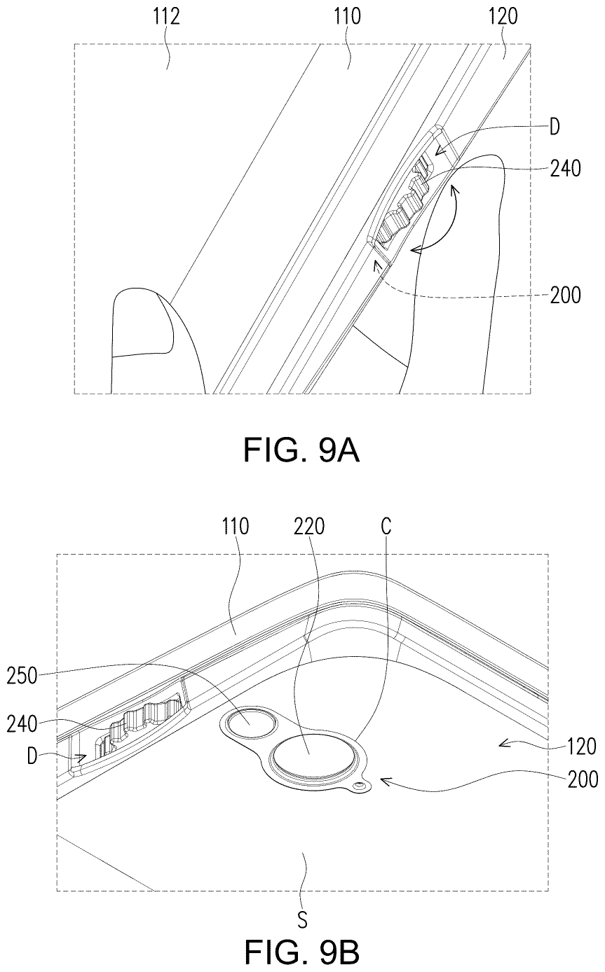

FIG. 8 is a perspective schematic diagram of the electronic device in FIG. 1 in a tablet state. FIG. 9A and FIG. 9B are different partial enlarged schematic diagrams of the electronic device in FIG. 8, respectively. Referring to FIG. 8 to FIG. 9B, in this embodiment, the electronic device 100 may switch to the tablet mode by folding the display body 110. Specifically, in this embodiment, the electronic device 100 further includes an angle sensor (not shown) used to sense the included angle between the display body 110 and the computing body 120. For example, the angle sensor may be connected to the hinge structure 130 to obtain rotation angle information of the hinge structure 130, and the processing unit switches the electronic device 100 to a laptop mode or the tablet mode according to the angle information. In other words, when the user bends the display body 110 or the computing body 120 to an open state, the processing unit switches the system of the electronic device 100 to the laptop mode. When the user folds the display body 110 or the computing body 120 to a closed state and the display module 112 faces outward, the processing unit switches the system of the electronic device 100 to the tablet mode. When the electronic device 100 is in the tablet mode, the camera window C faces away from the display surface of the display body 110, as shown in FIG. 8. In the tablet mode, as shown in FIG. 9, the user may still toggle the switching mechanism 240 at the position of the opening D in a manner similar to the laptop mode to switch one of the at least one camera unit 220 and the blocking member to be exposed at the camera window C, and cause the processing unit to control the display module 112 to display a corresponding display screen. In this way, by the configuration of the camera window C and the display surface of the display body 110, the user may hold the electronic device 100 for capturing images, and in addition to being able to intuitively view the display screen from the display body 110, may also easily and conveniently manually switch to different camera modes and automatically execute corresponding program software or provide privacy protection.

However, in this embodiment, the display body 110 further includes a touch module (not shown), configured in the housing of the display body 110 and electrically connected to the processing unit. The processing unit may control the display module 112 to display multiple software touch icons E and activate corresponding multiple software programs according to touch information of the display module 112. In other words, in the tablet mode, the user may directly touch the display module 112 to activate corresponding software programs, for example, photography, video recording, or multitasking application programs. In different embodiments, the processing unit may execute different software operations according to different types of touch actions (for example, clicking or dragging and sliding) by the user on the touch module, and the present invention is not limited thereto.

In addition, the processing unit may further control the display module 112 to display multiple software touch icons E and activate corresponding multiple software programs according to touch pressure information of the switching mechanism 240. In other words, in the tablet mode, the user may also activate corresponding software programs by touching and pressing the switching mechanism 240. Therefore, multiple interactive methods may be implemented according to different operating habits of the user. On the other hand, in the tablet mode, when at least one camera unit 220 is exposed at the camera window C, the processing unit may automatically activate the light-emitting unit 250 to provide illumination light according to the brightness of the display screen, or provide prompt information on whether to activate the light-emitting unit 250 according to the brightness of the display screen, and the present invention is not limited thereto.

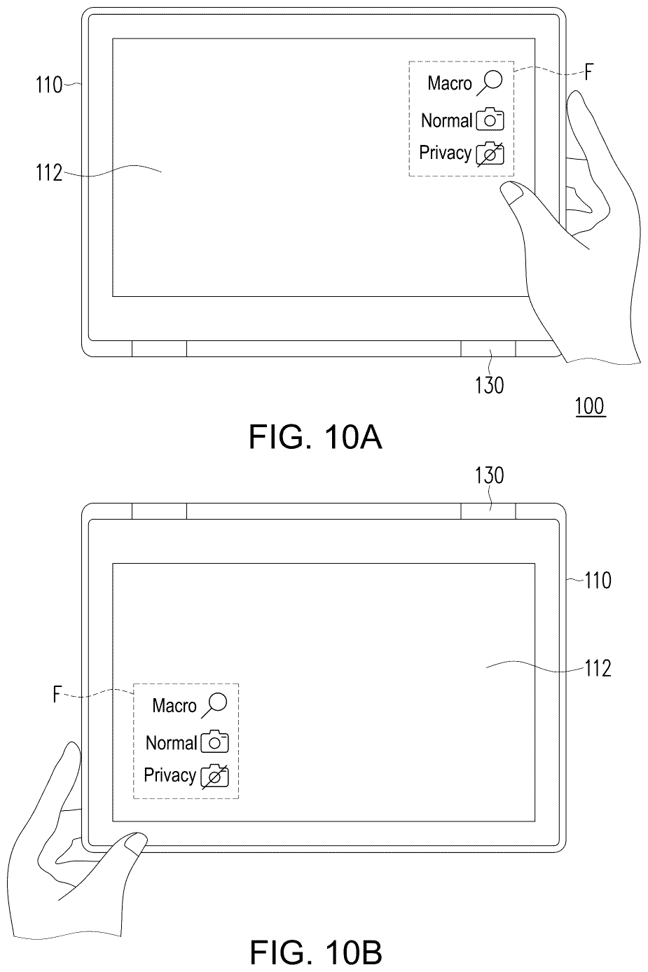

FIG. 10A and FIG. 10B are schematic diagrams of camera mode screens of the electronic device in FIG. 8, respectively. Referring to FIG. 10A and FIG. 10B, in this embodiment, the electronic device 100 further includes a motion sensor (not shown), for example, an Inertial Measurement Unit (IMU) including components such as an accelerometer and/or gyroscope, used to sense the directionality of the display module 112 and the switchable camera module 200 to provide direction information, whereby the processing unit may adjust the screen orientation of the display module 112 according to the direction information. Furthermore, in this embodiment, the display screen of the display module 112 includes a camera function icon F. When the electronic device 100 is in the tablet mode, the processing unit adjusts the position displayed of the camera function icon F on the display screen according to the positions of the switchable camera module 200 and the camera window C, so that the position of the camera function icon F corresponds adjacent to the switchable camera module 200 and the camera window C. For example, when the user holds the electronic device 100 in the tablet mode and the switchable camera module 200 is located at the back of the upper right corner (that is, the hinge body 130 does not rotate), the processing unit adjusts the camera function icon F displayed by the display module 112 adjacent to the upper right corner position of the display module 112. When the switchable camera module 200 is located at the back of the lower left corner (that is, the hinge body 130 rotates 180 degrees), the processing unit adjusts the camera function icon F displayed by the display module 112 adjacent to the lower left corner position of the display module 112. In this way, appropriate display screens and icon positions may be further provided according to the handheld direction of the user.

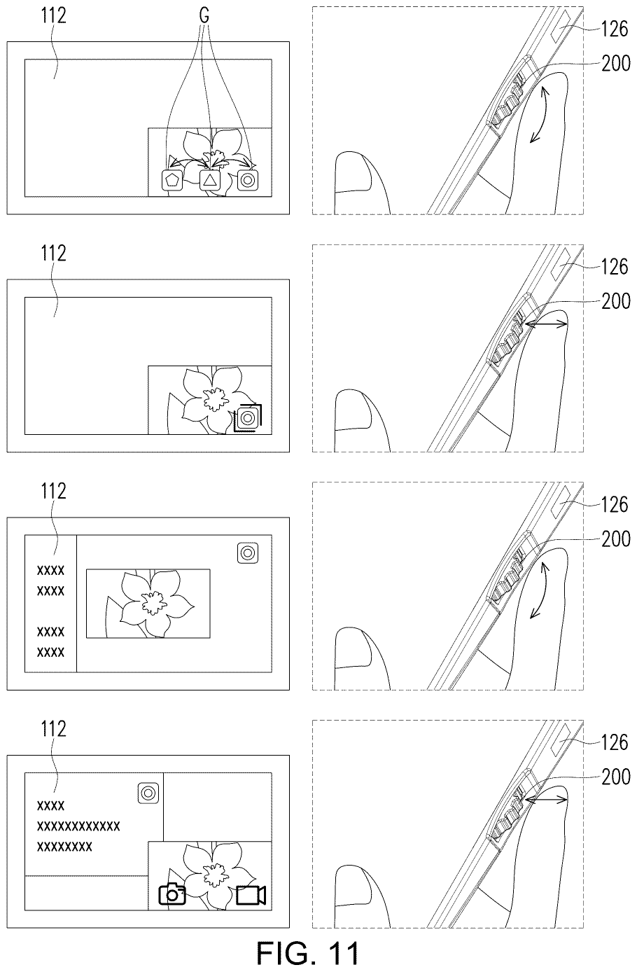

FIG. 11 is a schematic diagram showing the correspondence between the switchable camera module and camera mode screens of the electronic device in FIG. 1 under different operations. Referring to FIG. 11, in this embodiment, the computing body 120 of the electronic device 100 further includes an interactive component 126 configured adjacent to the switchable camera module 200. The processing unit may be used to execute predetermined software functions according to pressing information of the interactive component 126, and the interactive component 126 may be understood as a confirmation button. For example, after performing capture, the processing unit may control the display module 112 to display corresponding software function icons G according to the captured information, for example, generative AI software. At this time, the user may select the required software function icon G by operating the switching mechanism 240. Then, after selecting the required software function icon G, the user may activate the software program corresponding to the selected software function icon G by pressing the switching mechanism 240 or the interactive component 126. During execution of the software program, the user may further switch to different software operations by toggling the switching mechanism 240 and then pressing the switching mechanism 240/interactive component 126, but the invention is not limited thereto.

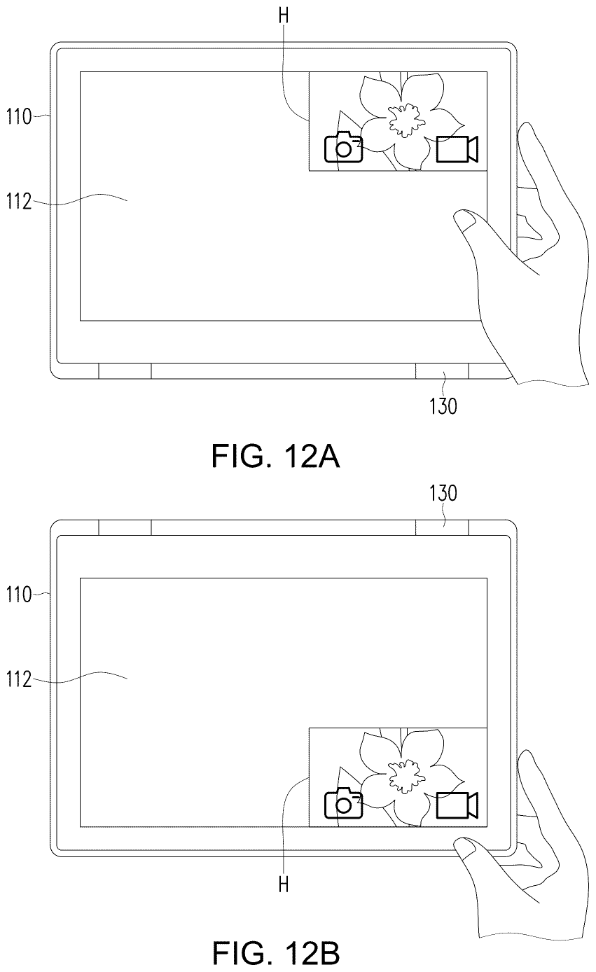

FIG. 12A and FIG. 12B are schematic diagrams of camera mode screens of the electronic device in FIG. 8 in different directions, respectively. Referring to FIG. 12A and FIG. 12B, similar to the effect of providing appropriate display screens and icon positions as shown in FIG. 10A and FIG. 10B, in this embodiment, when the camera unit 220 is exposed at the camera window C and the camera function is activated, the processing unit may adjust the screen orientation displayed of the display module 112 according to direction information. For example, when the switchable camera module 200 is located at the back of the upper right corner (that is, the hinge body 130 does not rotate) and the camera function is activated, the processing unit adjusts a real-time camera screen H displayed by the display module 112 to be adjacent to the upper right corner position of the display module 112. When the switchable camera module 200 is located at the back of the lower left corner (that is, the hinge body 130 rotates 180 degrees) and the camera function is activated, the processing unit adjusts the real-time camera screen H displayed by the display module 112 to be adjacent to the lower left corner position of the display module 112. In this way, in the tablet mode, appropriate display screens may be further provided according to the handheld direction of the user. On the other hand, in the tablet mode, regardless of how the screen orientation displayed of the display module 112 is rotated, the real-time camera screen H is always away from the hinge body 130 and close to the switchable camera module 200, thereby prompting the user of the position of the switching mechanism 240 of the switchable camera module 200.

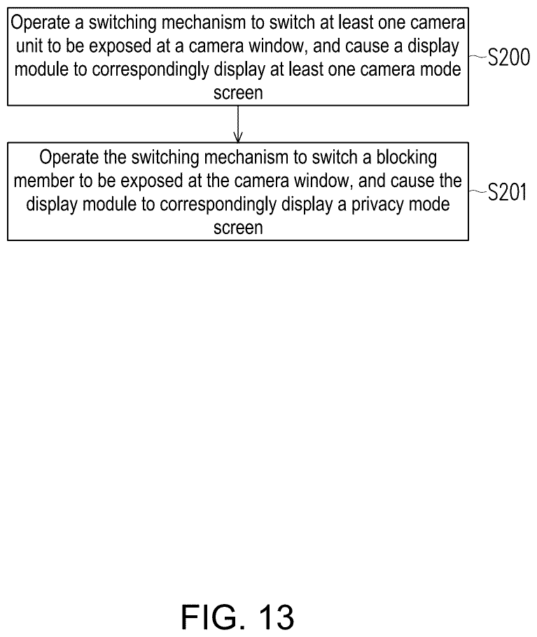

FIG. 13 is a step flow chart of an operating method of an electronic device according to an embodiment of the invention. Referring to FIG. 1 to FIG. 2B, FIG. 4A to FIG. 4C, and FIG. 13, this embodiment provides an operating method of an electronic device 100, which may be applied at least to the electronic device 100 shown in FIG. 1, so this is used as an example for illustration, but the invention is not limited thereto. In this embodiment, first, Step S200 is performed to operate the switching mechanism 240 to switch at least one camera unit 220 to be exposed at the camera window C, and cause the display module 112 to correspondingly display at least one camera mode screen, as shown in FIG. 4A and FIG. 4B, and Step S201 is performed to operate the switching mechanism 240 to switch the blocking member 230 to be exposed at the camera window C, and cause the display module 112 to correspondingly display a privacy mode screen, as shown in FIG. 4C. Specifically, the user may operate the portion of the switching mechanism 240 of the switchable camera module 200 exposed from the opening D of the computing body 120, thereby causing one of the first camera unit 222, the second camera unit 224, and the blocking member 230 to be switched to be exposed at the camera window C of the computing body 120, and the processing unit controls the display module 112 to display a corresponding camera mode screen according to the object exposed at the camera window C. In this way, different camera modes may be switched to by simple operation and corresponding program software may be automatically executed or privacy protection may be provided.

In summary, in the electronic device and the operating method thereof of the invention, the electronic device includes a display body, a hinge structure, and a computing body. The display body includes a display module, the computing body includes a processing unit, a camera window, and a switchable camera module, and has opposite first and second ends. The hinge structure is pivotally connected between the first end and the display body. The camera window is configured on an operation surface of the computing body. The switchable camera module and the camera window are configured adjacent to the second end, and the switchable camera module includes a carrier element, at least one camera unit, a blocking member, and a switching mechanism. The at least one camera unit is configured on the carrier element. The blocking member is configured on the carrier element. The switching mechanism is connected to the carrier element for driving the carrier element. When the switching mechanism is operated to switch the at least one camera unit to be exposed at the camera window, the processing unit controls the display module to correspondingly display at least one camera mode screen. In addition, when the switching mechanism is operated to switch the blocking member to be exposed at the camera window, the processing unit controls the display module to correspondingly display a privacy mode screen. In this way, different camera modes may be switched to by simple operation and corresponding program software may be automatically executed or privacy protection may be provided.

Although the invention has been disclosed above with embodiments, they are not used to limit the invention. Any person having ordinary knowledge in the technical field may make slight modifications and refinements without departing from the spirit and scope of the invention. Therefore, the protection scope of the invention shall be defined by the appended claims

What is claimed is:

1. An electronic device, comprising:
a display body comprising a display module;
a hinge structure, pivotally connected to the display body; and
a computing body pivotally connected to the display body, wherein the computing body comprises a processing unit, a camera window, and a switchable camera module and has a first end and a second end opposite to each other, the first end is pivotally connected to the hinge structure, the camera window is configured on an operation surface of the computing body, the switchable camera module and the camera window are arranged adjacent to the second end, and the switchable camera module comprises:
a carrier element;
at least one camera unit configured on the carrier element;
a blocking member configured on the carrier element; and
a switching mechanism connected to the carrier element, and configured to drive the carrier element to switch, such that only one of the at least one camera unit and the blocking member is exposed at the camera window;
wherein when the at least one camera unit is exposed at the camera window, the processing unit controls the display module to display a camera mode screen, and when the blocking member is exposed at the camera window, the processing unit controls the display module to display a privacy mode screen.

2. The electronic device as claimed in claim 1, wherein the computing body further comprises a keyboard module and a touchpad exposed on the operation surface, the keyboard module is configured adjacent to the first end, the touchpad is configured adjacent to the second end, and the switchable camera module and the camera window are located on same side of the touchpad.

3. The electronic device as claimed in claim 1, wherein there are two side edges opposite to each other between the first end and the second end, and the switchable camera module and the camera window are located adjacent to one of the two side edges.

4. The electronic device as claimed in claim 3, wherein one of the two side edges adjacent to the switchable camera module and the camera window has an opening, and the switching mechanism is partially exposed at the opening.

5. The electronic device as claimed in claim 4, wherein the carrier element is a rotating disk, the switching mechanism is a driving gear and meshes with the carrier element, and the switching mechanism partially exposed at the opening is configured to allow a user to toggle within the opening to drive the carrier element to rotate.

6. The electronic device as claimed in claim 4, wherein the carrier element and the switching mechanism are an integrally formed sliding component, and the switching mechanism has a toggle lever, exposed to a portion of the opening, and is configured to allow a user to slide within the opening along an extending direction of the corresponding two side edges to drive the carrier element.

7. The electronic device as claimed in claim 1, wherein the at least one camera unit comprises a first camera unit and a second camera unit, and an optical zoom magnification of the first camera unit is different from an optical zoom magnification of the second camera unit.

8. The electronic device as claimed in claim 7, wherein when the first camera unit or the second camera unit is exposed at the camera window, the processing unit controls the display module to display a camera mode confirmation screen.

9. The electronic device as claimed in claim 8, wherein when the display module displays the camera mode confirmation screen, the processing unit controls the display module to display a first camera mode screen or a second camera mode screen according to confirmation information.

10. The electronic device as claimed in claim 1, further comprising an angle sensor configured to sense a rotation angle of the hinge structure to obtain angle information, and the processing unit switches the electronic device to a laptop mode or a tablet mode according to the angle information.

11. The electronic device as claimed in claim 10, wherein when the electronic device is in the tablet mode, the camera window faces away from a display surface of the display body.

12. The electronic device as claimed in claim 10, further comprising a motion sensor configured to sense a directionality of the display module and the switchable camera module to provide direction information, and when the electronic device is in the tablet mode, the processing unit adjusts a screen orientation displayed of the display module according to the direction information.

13. The electronic device as claimed in claim 12, wherein a display screen of the display module comprises a camera function icon, when the electronic device is in the tablet mode, the processing unit adjusts a position displayed of the camera function icon on the display screen according to positions of the switchable camera module and the camera window, so that a position of the camera function icon corresponds adjacent to the switchable camera module and the camera window.

14. The electronic device as claimed in claim 12, wherein the switchable camera module further comprises a light-emitting unit electrically connected to the processing unit, and when the electronic device is in the tablet mode, and the at least one camera unit is exposed at the camera window, the processing unit is configured to activate the light-emitting unit to provide illumination light.

15. The electronic device as claimed in claim 1, wherein the display body further comprises a touch module electrically connected to the processing unit, and the processing unit controls the display module to display multiple software touch icons and activate corresponding multiple software programs according to touch information of the display module.

16. The electronic device as claimed in claim 1, wherein the processing unit controls the display module to display multiple software touch icons and activate corresponding multiple software programs according to touch pressure information of the switching mechanism.

17. An operating method of an electronic device, wherein the electronic device comprises a display body, a hinge structure, and a computing body, the display body comprises a display module, the computing body comprises a processing unit, a camera window, and a switchable camera module and has a first end and a second end opposite to each other, the hinge structure is pivotally connected between the first end and the display body, the camera window is configured on an operation surface of the computing body, the switchable camera module and the camera window are arranged adjacent to the second end, and the switchable camera module comprises a carrier element, at least one camera unit, a blocking member, and a switching mechanism, wherein the at least one camera unit is configured on the carrier element, the blocking member is configured on the carrier element, and the switching mechanism is connected to the carrier element and configured to drive the carrier element, wherein the operating method of the electronic device comprises:
operating the switching mechanism to switch the at least one camera unit to be exposed at the camera window, and causing the display module to correspondingly display at least one camera mode screen; and
operating the switching mechanism to switch the blocking member to be exposed at the camera window, and causing the display module to correspondingly display a privacy mode screen.

18. The operating method of the electronic device as claimed in claim 17, wherein the at least one camera unit comprises a first camera unit and a second camera unit having different optical zoom magnifications, and the operating method of the electronic device further comprises:
controlling the display module to display a first camera mode screen or a second camera mode screen according to confirmation information.

19. The operating method of the electronic device as claimed in claim 17, further comprising:
sensing an included angle between the display body and the computing body to provide angle information; and
switching the electronic device to a laptop mode or a tablet mode according to the angle information.

20. The operating method of the electronic device as claimed in claim 19, wherein when the electronic device is in the tablet mode, a display screen of the display module further comprises a camera function icon, and the operating method of the electronic device further comprises:
sensing a directionality of the display module and the switchable camera module to provide direction information;
adjusting a screen orientation displayed of the display module according to the direction information; and
controlling a position displayed of the camera function icon on the display screen, so that a position of the camera function icon corresponds adjacent to the switchable camera module and the camera window.
